(19) United States
(12) Patent Application Publication
(10) Pub. No.: US 2008/0011026 A1
(43) Pub. Date: Jan. 17, 2008

(54) Combination and key operated padlock with indicator for advising that the clock has been opened with a key

(76) Inventor: Chien-Chien Huang, Luggang Village (TW)

Correspondence Address: PRO-TECHTOR INTERNATIONAL SERVICES, 20775 NORADA CT., SARATOGA, CA, 95070, US

(21) Appl. No.: 11/487,561

(22) Filed: Jul. 14, 2006

(51) Int. Cl. E05B 37/02

(52) U.S. Cl. 70/21

(57) ABSTRACT

A combination and key operated padlock includes a housing including a top aperture, a dial assembly, a key turning mechanism, a spring-biased pivot assembly, a spring-biased push button, a shackle including one spring-biased leg and the other leg having a slot proximate its terminating end, a spring-biased T-shaped detent mechanism, and a spring-biased pivotal indicator. Inserting a key and clockwise turning the key will open the padlock and project an indication member out of the aperture for advising an owner of the padlock that the padlock has been opened by means of a key. Turning the dials to a correct combination will unlock the padlock and retract the indication member into the aperture again.

### BACKGROUND OF THE INVENTION

1. Field of Invention

The present invention relates to combination and key operated padlocks and more particularly to such a combination and key operated padlock having a retractable indication member for advising the owner of the padlock that the padlock has been opened by means of a key.

2. Related Art

Combination and key operated padlocks (i.e., padlocks that can be operated by combination or by key) are well known in the art. For example, U.S. Pat. No. 6,928,842 B01 discloses a combination lock having a key opening mechanism. Also, U.S. Pat. No. 6,792,778 B1 discloses a combination lock. However, both documents do not disclose a combination and key operated padlock having an indicator member for advising the owner of the lock that the lock has been opened with a key. Thus, the need for improvement still exists.

### SUMMARY OF THE INVENTION

It is therefore an object of the present invention to provide a combination and key operated padlock having a retractable indication member for advising the owner of the padlock that the padlock has been opened by means of a key and retracting the indication member into the padlock again is made possible only by turning dials to a correct combination.

To achieve the above and other objects, the present invention provides a combination and key operated padlock comprising a housing including a top aperture, a plurality of openings formed thereon, and a top hole; a dial assembly mounted in the housing and including a plurality of wheel-like dials, a plurality of sleeves axially moveably fastened in the dials, a spring-biased bar axially moveably fastened in the sleeves and including an end enlargement disposed externally of the dials and the sleeves; a key turning mechanism including a cylinder mounted in the housing, a keyhole on an outer end of the cylinder, and a projection of half circular section projecting from an inner end of the cylinder; a spring-biased pivot assembly pivotably mounted in the housing and including a latch extended toward the hole, the latch having a locking dog at an open end, a projecting engagement member urged against the flat of the projection in a locked position, and a protuberance opposite the latch; a spring-biased push button disposed on the pivot assembly and co-pivotably disposed therewith; a shackle including one spring-biased leg pivotably secured to the top of the housing, and the other leg having a terminating end received in the hole in the locked position, and a slot proximate the terminating end and engaged with the locking dog in the locked position; a substantially T-shaped detent mechanism including a sliding member proximate the projection, a spring-biased stop member provided perpendicular to the sliding member, and a tab projecting from an open end of the stop member; and a spring-biased pivotal indicator including an arm stopped by the tab in the locked position, an indication member formed at one end of the arm and concealed in the housing in the locked position, and a catch opposite the arm and adapted to urge against the engagement member; whereby inserting a key into the keyhole to clockwise turn the projection to move the sliding member toward the top of the housing will elastically move the stop member to disengage the tab with the arm so as to clockwise pivotably move the arm for projecting the indication member out of the aperture; continuing the turning of the projection will pivot the engagement member to cause the locking dog to clear the slot and pivot the other leg out of the hole about one leg relative to the housing; inserting the other leg into the hole again and then counterclockwise turning the projection will counterclockwise pivot the pivot assembly to cause the locking dog to enter into the slot to lock the shackle with the indication member maintained in the projected state and the sliding member maintained in the current position; turning the dials to a correct combination will unlock the bar and pressing the push button will cause the nose to push the bar and the protuberance inward to cause the pivot assembly to clockwise pivot for causing the locking dog to clear the slot and pivot the other leg out of the hole about one leg relative to the housing with the engagement member pivoted clockwise to engage with the catch and counterclockwise pivot the catch until the indication member retracts into the aperture and the sliding member elastically moves back to its original position prior to releasing the push button to clockwise pivot the arm until being stopped by the tab; and inserting the other leg into the hole again will lock the padlock with the indication member maintained in the retracted state.

The above and other objects, features and advantages of the present invention will become apparent from the following detailed description taken with the accompanying drawings.

### BRIEF DESCRIPTION OF THE DRAWINGS

FIG. 1 is an exploded view of a preferred embodiment of combination and key operated padlock (i.e., lock) according to the invention;

FIG. 2 is a front view of the assembled lock;

FIG. 3 is a front view of the lock of FIG. 2 with the front shell of the housing removed and the shackle locked;

FIG. 4 is a view similar to FIG. 3 with the shackle being unlocked by inserting a key into the housing and turning the inserted key;

FIG. 5 is a view similar to FIG. 3 with the shackle unlocked after fully turning the inserted key;

FIG. 6 is a view similar to FIG. 3 with the shackle locked again after turning the inserted key in an opposite direction where the indication member is exposed for advising the owner of the lock that the lock has been opened with a key;

FIG. 7 is a front view of the lock of FIG. 6 with the cover mounted and the key removed;

FIG. 8 is a view similar to FIG. 3 with the shackle unlocked and pivoted a predetermined angle relative to the housing after entering a correct combination where the indication member is being concealed; and

FIG. 9 is a view similar to FIG. 8 where the indication member is completely concealed in the housing.

### DETAILED DESCRIPTION OF THE INVENTION

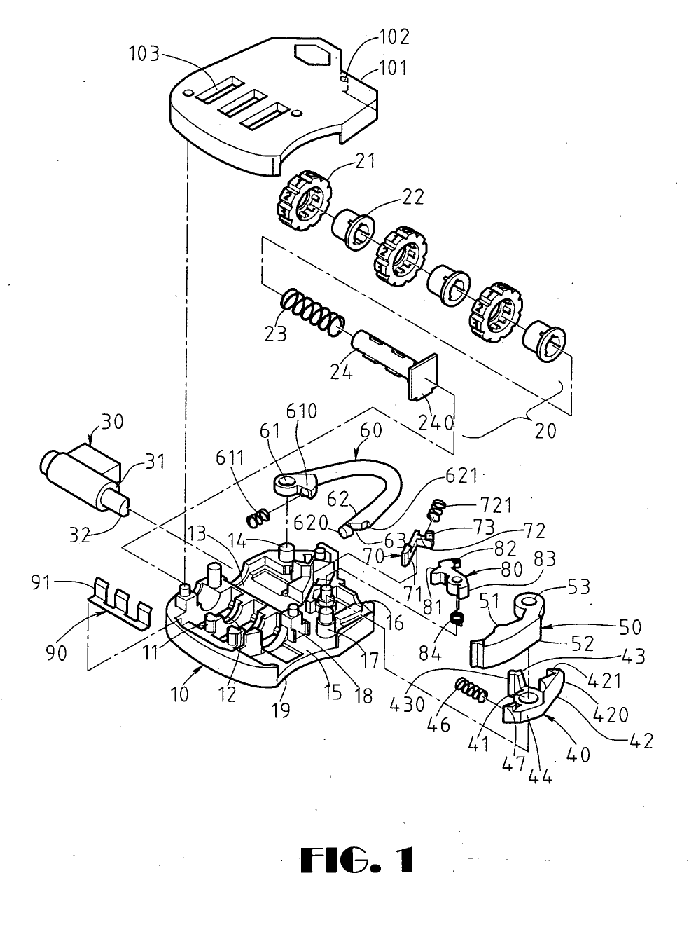

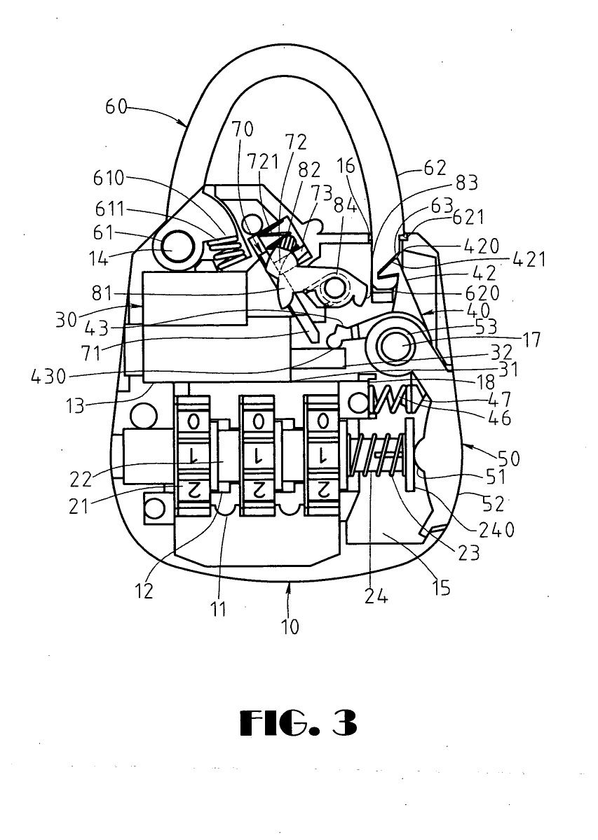

Referring to FIGS. 1 to 9, a combination and key operated padlock in accordance with a preferred embodiment of the invention comprises a housing 10, a dial assembly 20, a key turning mechanism 30, a pivot assembly 40, a push button 50, a U-shaped shackle 60, a detent mechanism 70, an indicator 80, and a leaf spring 90. Each component will be described in detail below.

The substantially rectangular housing 10 comprises a cover 101 having an aperture 102 on a top wall, three rectangular first openings 103 formed therethrough, and a plurality of peripheral recesses (not numbered); and a base (not numbered) including, on its inner surface, a plurality of spaced raised seats 11 having a half-circular groove 12, a compartment 13 parallel to the seats 11, a pin 14 at one corner, a cavity 15 at a right side, a hole 16 on a top wall, a post 17 adjacent the cavity 15, a receptacle 18 in the cavity 15 adjacent the post 17, and a second opening 19 formed on the mouth of the cavity 15. The cover 101 is secured onto the housing 10 by a snapping mechanism employing projections and holes well known in the art.

The dial assembly 20 is anchored on the grooves 12 and comprises three wheel-like dials 21 having a plurality of teeth around its inner surface, three sleeves 22 fitted in the dials 21, a bar 24 having a plurality of sets of projections (not numbered) on its peripheral surface of its shank portion inserted into the sleeves 22, and a flat end enlargement 240, and a coil spring 23 put on the shank portion of the bar 24 for urging the bar 24 against a detent well proximate the second opening 19 for slidably fastening the bar 24.

The key turning mechanism 30 comprises a cylinder 31 mounted in the compartment 13, a side protuberance (not numbered) rested upon a flat of the base of the housing 10, an outer keyhole (not numbered) fitted in an opening of the compartment 13, and a projection 32 of half circular section projecting from an inner end of the cylinder 31.

The pivot assembly 40 is provided in the cavity 15 and comprises a hole 41 pivotably put on the post 17, a latch 42 extended toward the hole 16, the latch 42 having a locking dog 420 at an open end, the locking dog 420 having an arcuate slope 421, a projecting engagement member 43 having a round end 430 urged against the flat of the projection 32 in a locked position, a body 44 provided on the second opening 19, a protuberance 47 projecting from the body 44, and a coil spring 46 biased between the protuberance 47 and the receptacle 18.

The push button 50 comprises a nose 51 at an inner surface urged against the enlargement 240, a projecting arm 52 urged upwardly by the protuberance 47 for closing the second opening 19 in the locked position, and a hole 53 at one end put on the post 17 with the pivot assembly 40 disposed thereunder such that both the push button 50 and the pivot assembly 40 can pivot about the post 17.

The shackle 60 comprises an end hole 61 at one leg pivotably put on the pin 14, a protrusion 610 adjacent the hole 61, a coil spring 611 biased between the protrusion 610 and an internal member of the housing 10 for enabling the pivoted shackle 60 to return to its original position once the pivotal force is released, the other leg 62 having a terminating end 620 received in the hole 16 in a locked position, the terminating end 620 having an arcuate shape so as to facilitate the insertion of the other leg 62 into the hole 16 or the removal from the same, a slot 63 proximate the terminating end 620 and engaged with the locking dog 420 in the locked position, and a notch 621 on a top of the slot 63 for fastening the locking dog 420 in the slot 63.

The T-shaped detent mechanism 70 comprises a sliding member 71 adapted to slide within the housing 10 to approach the projection 332 or move away from same, a stop member 72 provided perpendicular to the sliding member 71, a coil spring 721 biased between the stop member 72 and an internal member of the housing 10, and a tab 73 projecting from an open end of the stop member 72.

The indicator 80 comprises an arm 81 stopped by the tab 73 in the locked position, an indication member 82 at one end of the arm adapted to conceal within the housing 10 in the locked position or project out of the aperture 102, a catch 83 opposite the arm 81 adapted to urge against the engagement member 43, and a torsion spring 84 put on a pin (not numbered) of the housing 10 and anchored between the pin and a hole (not numbered) of the indicator 80 so as to configure the indicator 80 as a pivotal member.

The leaf spring 90 is mounted to one side of the dial assembly 20 and has three arms 91 pressed against the peripheries of the dials 21 to assist in retaining the dials 21 in their current positions.

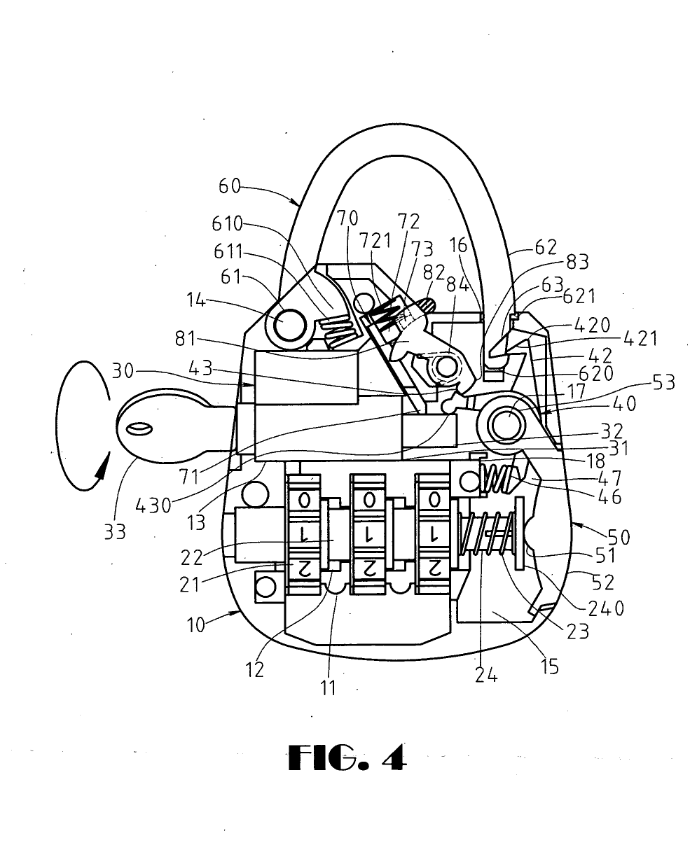

Referring to FIG. 4 again, a key opening operation of the lock will now be described in detail below. For example, this is the case of a government employee (e.g., an airport customs officer) inspecting the contents of a locked luggage. The customs officer can insert a key (e.g., an “override” key) 33 into the keyhole to clockwise turn the key turning assembly 30 (i.e., the projection 32) about half turn so as to move the sliding member 71 toward the top wall of the housing 10. The spring 721 is thus compressed by the stop member 72 to disengage the tab 73 with the arm 81. At the same time, the energized spring 84 pushes the arm 81 toward the top wall of the housing 10. As a result, the indication member 82 projects out of the aperture 102 of the housing 10.

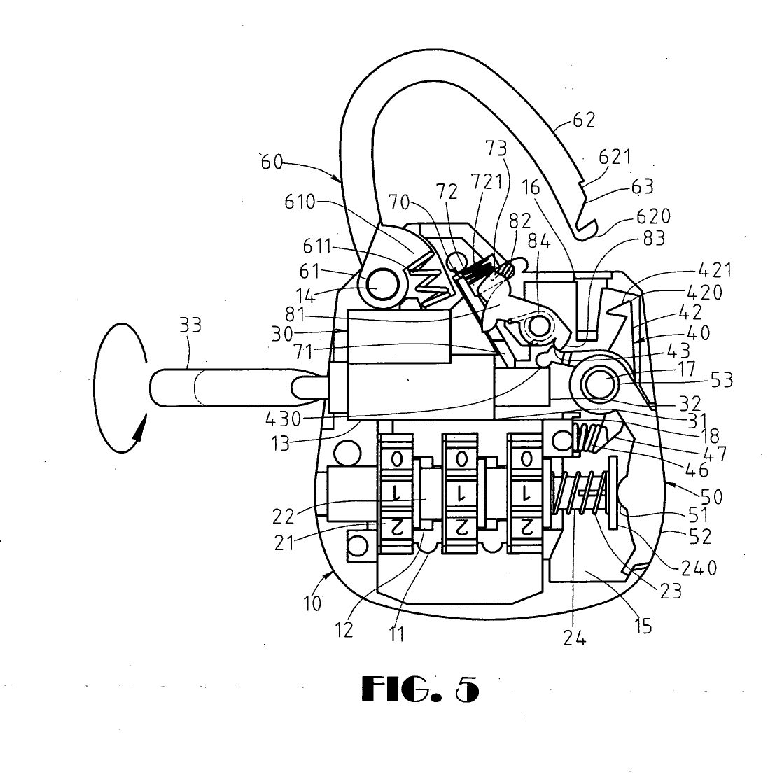

Referring to FIG. 5 again, continuing the turning of the projection 32 will pivot the round end 430 of the engagement member 43 about the post 17. Thus, the pivoting locking dog 420 clears the slot 63 to unfasten the shackle 60. As an end, the energized spring 611 exerts a force on the protrusion 610 to pivot the other leg 62 out of the hole 16, i.e., the lock is open.

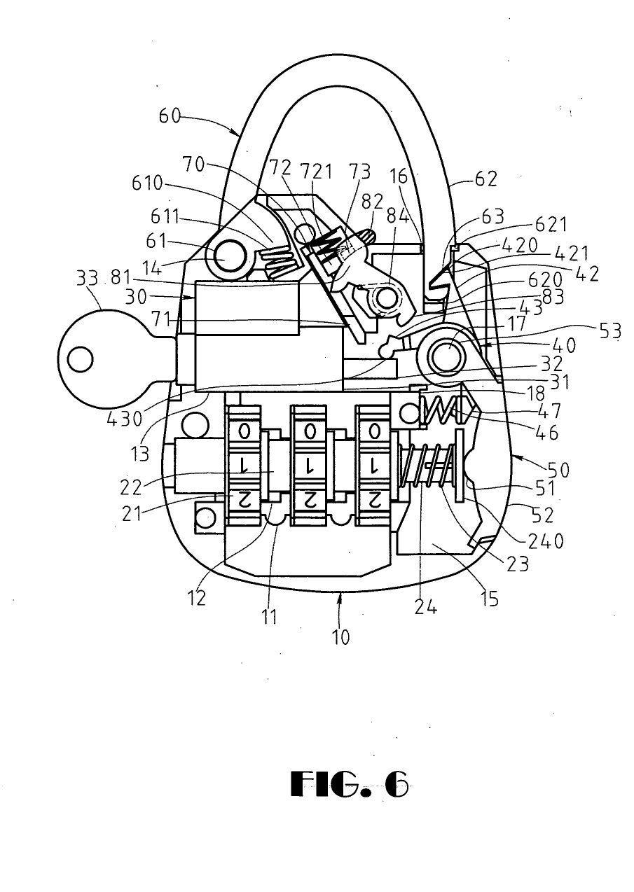

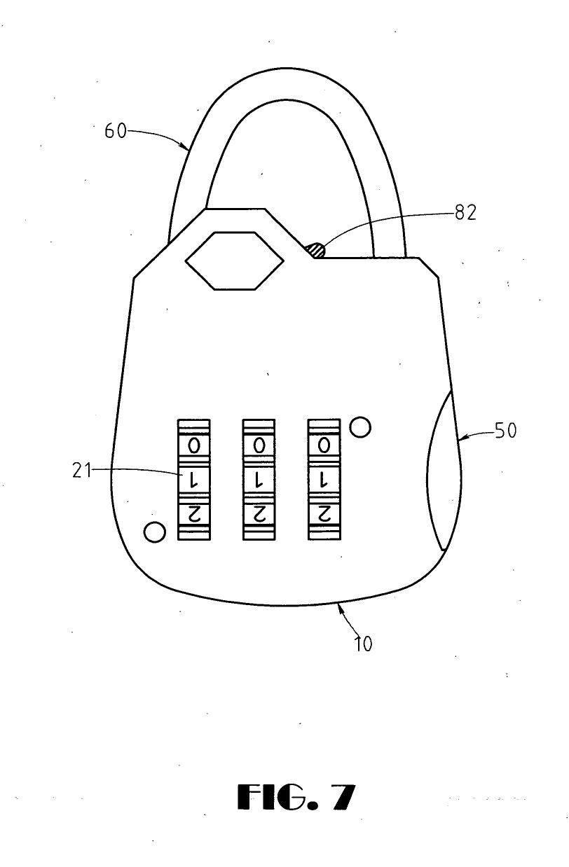

Referring to FIG. 6 again, the customs officer can insert the other leg 62 into the hole 16 again and then counterclockwise turn the key turning assembly 30 (i.e., the projection 32) so as to expand the spring 46 by pivoting the pivot assembly 40 in an opposite direction about the post 17. The round end 430 of the engagement member 43 thus is not urged by the projection 32. Also, the locking dog 420 enters into the slot 63 again to lock the shackle 60 (i.e., the lock is locked again). But both the detent mechanism 70 and the indicator 80 are disengaged with the pivot assembly 40. Hence, the spring 84 still exerts a force on the arm 81 to maintain the indication member 82 in the exposed state (see FIG. 7). This thus can advise the owner of the lock that the lock has been opened by means of a key for inspection. In addition, the moved sliding member 71 cannot return to its normal position by using the key 33 since the arm 81 is stilled stopped by the tab 73. As a result, the indication member 82 maintains in the exposed state after projecting out of the aperture 102 by using the key 33.

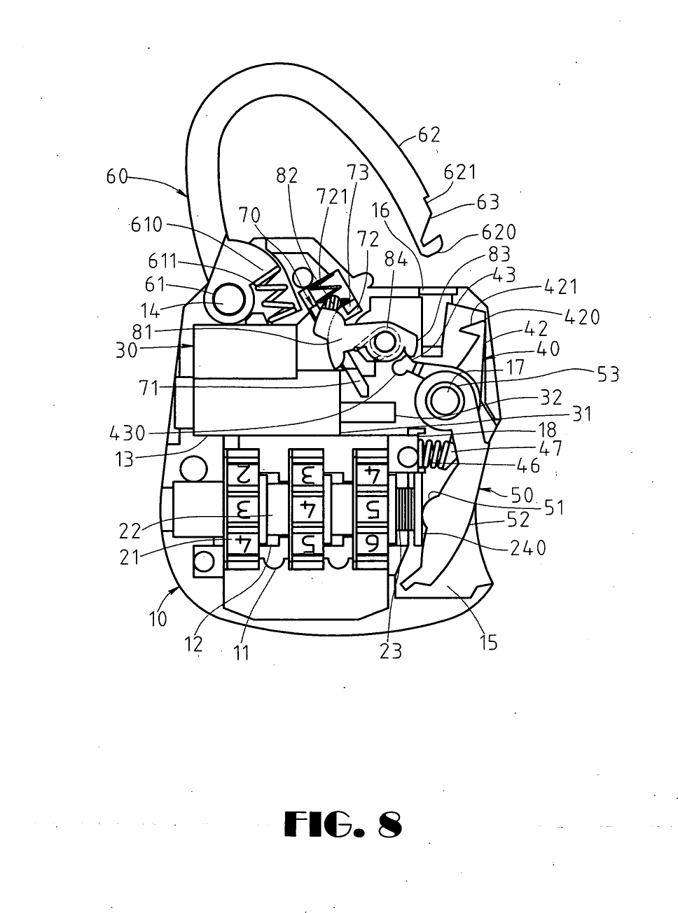

Referring to FIG. 8 again, retracting the indication member 82 into the aperture 102 again is made possible only by turning the dials 21 to a correct combination. This operation will now be described in detail below. An owner of the lock can turn the dials 21 until the correct set series of numbers (i.e., combination) are shown on the openings 103 of the cover 101. The bar 24 is thus unlocked by the sleeves 22. The owner of the lock then can press the push button 50 to press the nose 51 to push both the enlargement 240 and the bar 24 inward. Also, the protuberance 47 moves inward to cause the pivot assembly 40 to pivot inward the housing 10 (i.e., the same as the push button 50). Thus, the pivoting locking dog 420 clears the slot 63 to unfasten the shackle 60. As an end, the energized spring 611 exerts a force on the protrusion 610 to pivot the other leg 62 out of the hole 16, i.e., the lock is open.

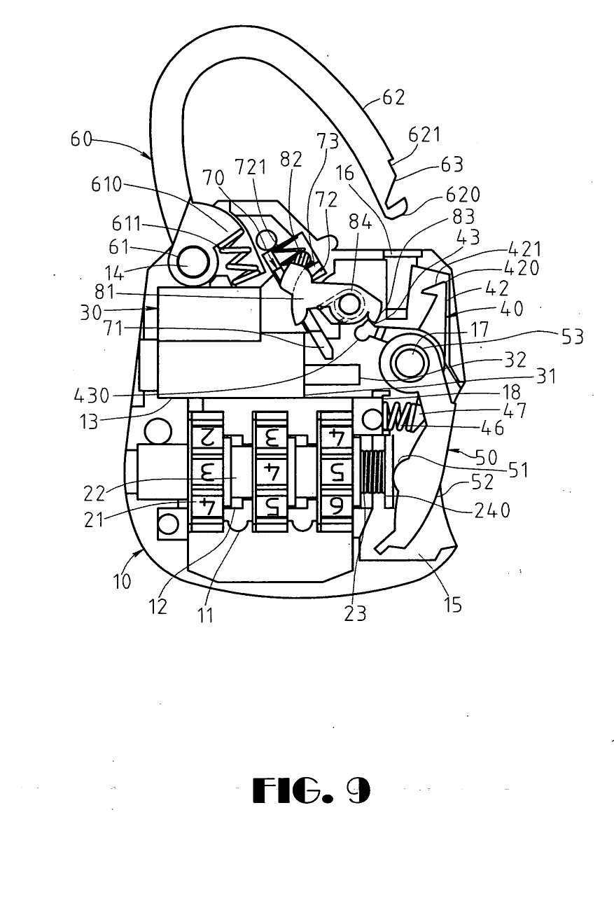

In the lock opening operation described in FIG. 8, the engagement member 43 pivots clockwise to engage with the catch 83 and pivot same counterclockwise to compress the spring 84 which in turn exerts a force on the arm 81 for counterclockwise pivoting the arm 81 and thus the indication member 82 until the indication member 82 completely retracts into the aperture 102 (i.e., within the housing 10). Also, the sliding member 71 moves away from the top wall of the housing 10 due to the expansion of the spring 721 and the disengagement of the arm 81 and the tab 73. At this time (see FIG. 9), the owner may release the push button 50 to cause the arm 81 to pivot clockwise a small angle until being stopped by the tab 73.

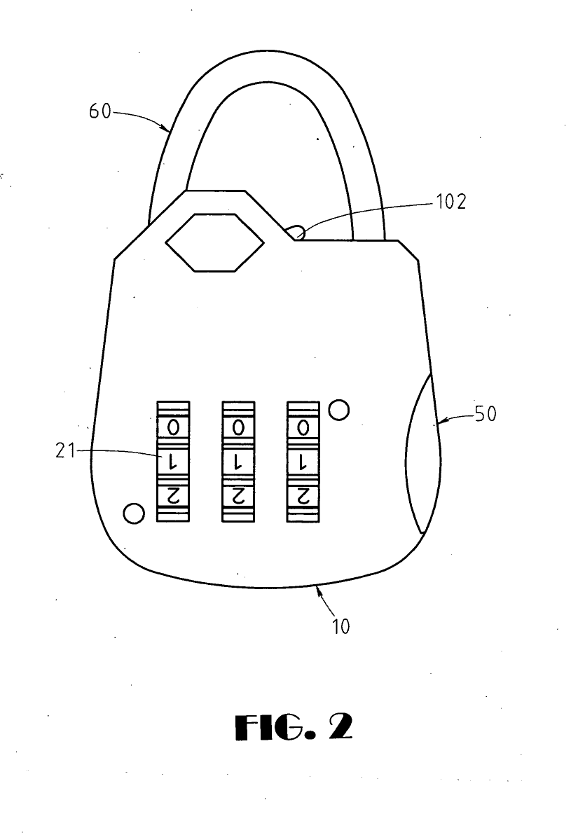

It is possible of inserting the other leg 62 into the hole 16 again to lock the lock. The indication member 82 maintains in its concealed state (see FIG. 2). That is, the only way of displaying the indication member 82 through the aperture 102 is by inserting the key 33 and turning same as described above. In brief, either the owner of the lock or a government officer can open the lock by means of a key. The indication member is thus displayed on the lock housing so as to advise the owner of the lock that the lock has been opened by a key.

While the invention herein disclosed has been described by means of specific embodiments, numerous modifications and variations could be made thereto by those skilled in the art without departing from the scope and spirit of the invention set forth in the claims.

What is claimed is:

1. A combination and key operated padlock comprising:
a housing including a top aperture, a plurality of openings formed thereon, and a top hole;
a dial assembly mounted in the housing and including a plurality of wheel-like dials, a plurality of sleeves axially moveably fastened in the dials, a spring-biased bar axially moveably fastened in the sleeves and including an end enlargement disposed externally of the dials and the sleeves;
a key turning mechanism including a cylinder mounted in the housing, a keyhole on an outer end of the cylinder, and a projection of half circular section projecting from an inner end of the cylinder;
a spring-biased pivot assembly pivotably mounted in the housing and including a latch extended toward the hole, the latch having a locking dog at an open end, a projecting engagement member urged against the flat of the projection in a locked position, and a protuberance opposite the latch;
a spring-biased push button disposed on the pivot assembly and co-pivotably disposed therewith;
a shackle including one spring-biased leg pivotably secured to the top of the housing, and the other leg having a terminating end received in the hole in the locked position, and a slot proximate the terminating end and engaged with the locking dog in the locked position;
a substantially T-shaped detent mechanism including a sliding member proximate the projection, a spring-biased stop member provided perpendicular to the sliding member, and a tab projecting from an open end of the stop member; and
a spring-biased pivotal indicator including an arm stopped by the tab in the locked position, an indication member formed at one end of the arm and concealed in the housing in the locked position, and a catch opposite the arm and adapted to urge against the engagement member; whereby
inserting a key into the keyhole to clockwise turn the projection to move the sliding member toward the top of the housing will elastically move the stop member to disengage the tab with the arm so as to clockwise pivotably move the arm for projecting the indication member out of the aperture;
continuing the turning of the projection will pivot the engagement member to cause the locking dog to clear the slot and pivot the other leg out of the hole about one leg relative to the housing;
inserting the other leg into the hole again and then counterclockwise turning the projection will counterclockwise pivot the pivot assembly to cause the locking dog to enter into the slot to lock the shackle with the indication member maintained in the projected state and the sliding member maintained in the current position;
turning the dials to a correct combination will unlock the bar and pressing the push button will cause the nose to push the bar and the protuberance inward to cause the pivot assembly to clockwise pivot for causing the locking dog to clear the slot and pivot the other leg out of the hole about one leg relative to the housing with the engagement member pivoted clockwise to engage with the catch and counterclockwise pivot the catch until the indication member retracts into the aperture and the sliding member elastically moves back to its original position prior to releasing the push button to clockwise pivot the arm until being stopped by the tab; and
inserting the other leg into the hole again will lock the padlock with the indication member maintained in the retracted state.
